(19) United States
(12) Patent Application Publication
(10) Pub. No.: US 2015/0257432 A1
(43) Pub. Date: Sep. 17, 2015

(54) Fruit dehydrator

(71) Applicant: Gary Lynn Leavitt, Saint George, UT (US)

(72) Inventor: Gary Lynn Leavitt, Saint George, UT (US)

(21) Appl. No.: 14/207,480

(22) Filed: Mar. 12, 2014

(51) Int. Cl. A23L 3/54; F26B 3/28

(52) U.S. Cl. CPC A23L 3/54; F26B 3/283

(57) ABSTRACT

The invention is directed towards the dehydration of food material with a device that utilizes both force heated air and infrared energy. The device and related method includes a housing unit, a heating element for increasing the temperature of the air, a blower to force air through the housing unit at least one tray to support the food material, an infrared element for creating infrared energy, temperature and humidity sensors and a control panel that includes a display panel. The user places food material in the housing unit, then may choose to dehydrate the food material by either forced air, infrared energy, or a combination. The user may also select a predetermined humidity level or temperature in which the device shuts down.

### BACKGROUND OF THE INVENTION

1. Field of the Invention

A fruit dehydrator to assist in dehydrating food.

2. Prior Art

The concept of dehydrating fruits and vegetables has an extensive history. Dehydration is a process in which the majority of the water in the material or food is withdrawn. Dehydrating fruits and vegetables prolong the life expectancy of fruits and vegetables. Also, many users believe that dehydration improves the taste and texture of the food. Depending on the fruit, vegetable, or material being dehydrated, the user may want the item to retain a small portion of water. In addition to dehydrating fruits and vegetables, other items such as herbs and flowers may be dehydrated.

Traditionally and historically, the most common method of dehydrating food is a method which utilizes energy from the sun. The food is placed in direct sunlight. The heat and infrared energy from the sun causes the food to lose water. Frequently the user will place the food on trays or netting to prevent insects and bugs from coming in contact with the food. The netting is generally made of very thin and translucent material that will still allow the sun's heat and infrared energy to reach the food. This netting material does not have the ability to protect the fruits and vegetables from larger animals or the weather.

The sun dehydration method has several limitations. It requires the user to frequently inspect the trays and food to ensure that no animals or other nuisances have interfered with the dehydration process. In addition, this method is only effective during a limited amount of time each day. Many times it takes several days to achieve the desired results. Despite these limitations, many users still prefer to dry their food in the sun. Many users believe that the sun's heat and infrared energy allow the food to dry more evenly and effectively. Also, the users believe this method preserves the nutritional value and taste over newer dehydration methods.

Because of the number of limitations of dehydrating food in the sun, many users utilize a mechanical device which is often referred to as a fruit dehydrator or a fruit drier. A fruit drier generally comprises a housing unit which contains several screens or trays, a heating element, a fan, and an optional control panel. The most commonly used controller is a simple on-off switch. The fruit is placed upon the screens or trays and placed inside the housing unit of the drier. The fan then blows air into the drier, pushing the air past the heating element which increases the air temperature. The heated air is then blown across the food. The air is then exported through openings in the fruit drier. This method is often referred to as heated force air dehydration.

While this method overcomes many of the negative aspects of the sun drying method, it also has several limitations. Once the fruit is at the desired moisture level, any additional time in the drier may over dry the fruit and waste electricity. This requires the user to frequently inspect the fruit drier. May users consider using this method less desirable than fruit dehydrated in the sun.

While the prior art does teach the use of utilizing both infrared energy and heated force air, the prior art still has several limitations. The majority of the prior art consists of complex large machines used for industrialized applications. For example, the Townsend U.S. Pat. No. 4,257,172, which describes a process utilizing a conveyer belt to pass material through an industrialized sized machine. Another example is Ono, U.S. Pat. No. 5,939,116, which teaches the use of an infrared dryer of food under reduced pressure at low temperatures. Similar to Townsend, the Ono invitation requires the use of an industrialized sized machine. It is not practical for an individual user to purchase a large industrialized machine. In addition, many users believe that this industrialized method of dehydration, dries the food too quickly and which causes the food to lose taste and vitamins. Nor does the prior art give the user the ability to control the options of varying the dehydration condition. Therefore, the individual users wanting to dehydrate food must choose between utilizing the sun or a heated force air fruit drier.

Thus, there is a recognized need in the art for a small dehydrator which allows an individual user to obtain both the benefits of dehydrating food with force air, infrared energy, or a combination of the two. In addition, providing a dehydrator with a controller that utilizes sensors such as temperature, humidity levels, or timers to control the dehydrator process.

### SUMMARY OF THE INVENTION

The dehydrator invention utilizes a housing unit, which contains a traditional heating element, a fan for blowing heated air over the food, an infrared energy emitter, a humidity sensor and a temperature sensor. In operation, the user would have the ability to utilize either the heating element, the infrared radiation emitter, or a combination of both. The fruit drier would be controlled by the humidity and temperature sensor which gives the user feedback and may be adjusted by the user to automatically turn off the dehydrator. Additionally, a reflective material, such as stainless steel, is located on the interior wall of the housing unit that reflects the infrared energy and heat to achieve a uniform dehydration process.

### DESCRIPTION OF THE DRAWINGS

The invention may take form in certain parts and arrangement of parts, and preferred embodiment of which will be described in detail in the specification and illustrated in the accompany drawing, which for a part hereof:

FIG. 1 shows a side plan view of the dehydrator of the invention showing typical use with the control panel and display panel, also showing the access door closed;

FIG. 2 shows a cross section of the invention showing the heating elements and an infrared element, in addition, showing the infrared rays which will be invisible to the user;

FIG. 3 shows a cross section of the invention showing the heating elements and an infrared element, in addition, showing the heated air flow which will be invisible to the user;

FIG. 4 shows a front view of the invention showing the access door open and the typical location of the trays in use;

FIG. 5 shows a back view of the invention with an exploded perspective view of the air filter and air filter cover.

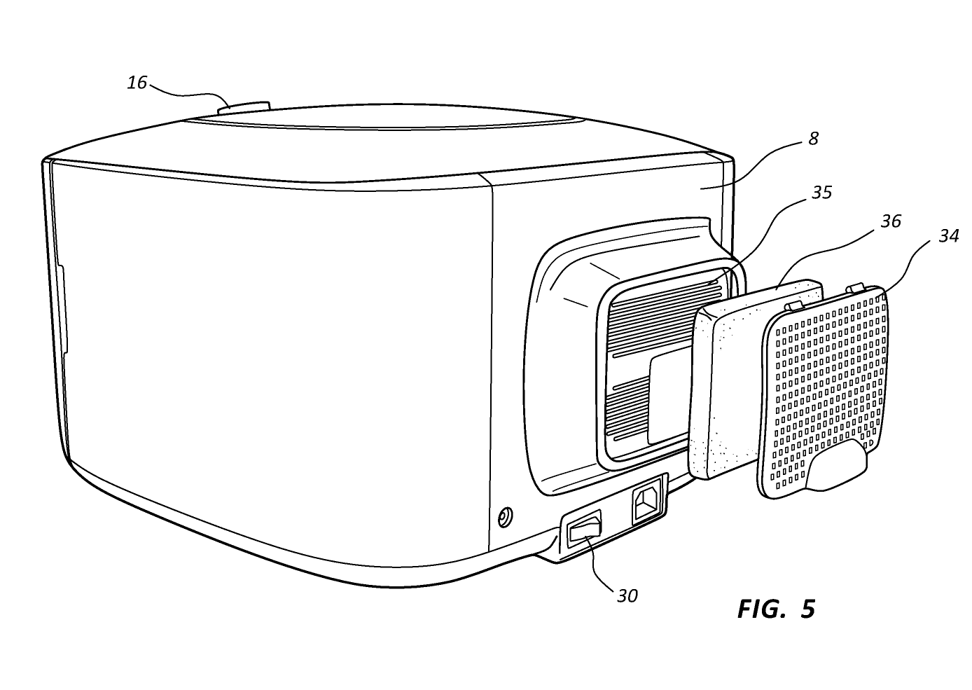

Drawing -Reference Numbers

| | |
|---|---|
| 2 | dehydrator |
| 4 | housing unit |
| 6 | front door |
| 8 | back panel |
| 10 | sidewall |
| 12 | bottom |
| 14 | top |
| 15 | confined space |
| 16 | dial |
| 18 | button |
| 19 | control panel |
| 20 | display panel |
| 22 | reflector |
| 24 | tray |
| 25 | brackets |
| 26 | infrared element |
| 27 | infrared energy |
| 28 | heating element |
| 30 | blower |
| 31 | fan |
| 34 | filter cover |
| 35 | vent opening |
| 36 | air filter |
| 37 | side ports |
| 40 | humidity sensor |
| 41 | temperature sensor |
| 42 | light display |

### DETAILED DESCRIPTION OF THE PREFERRED EMBODIMENTS

In the following description of the invention, certain terminology is used for the purpose of reference only, and is not intended to be limiting. Terms such as “upper”, “lower”, “above”, and “below,” refer to directions in the drawings to which reference is made. Terms such as “inward” and “outward” refer to directions towards and away from, respectively, the geometric center of the component described. Terms such as “side”, “top”, “bottom,” “horizontal,” and “vertical,” describe the orientation of portions of the component within a consistent but arbitrary frame of reference which is made clear by reference to the text and the associated drawings describing the component under discussion. Such terminology includes words specifically mentioned above, derivatives thereof, and words of similar import.

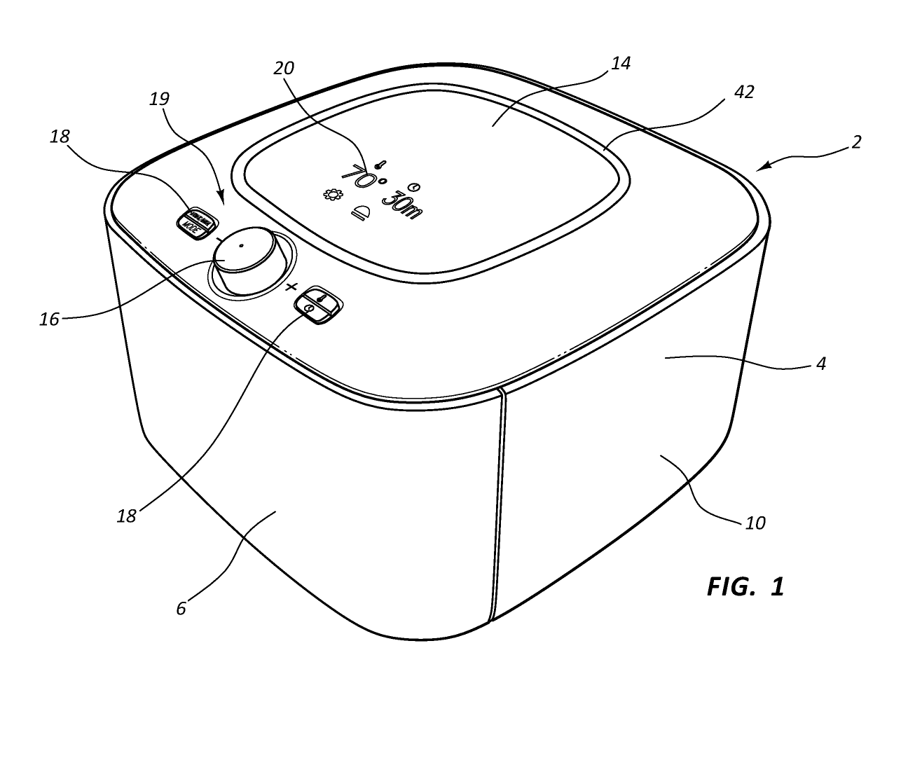

In the preferred embodiment the dehydrator 2 is illustrated in FIG. 1, which includes a housing unit 4. The housing unit 4 is generally shaped like a box, with a front door 6, a back panel 8, two side walls 10, a bottom 12, and a top 14 creating a confided space 15 within housing unit 4. As illustrated in FIG. 1 the typical dimensions are approximately 400 cm wide 460 cm long and 300 cm high. Although the housing unit 4 is shaped like a box and the dimensions are described above, one skilled in the art will recognize that the housing unit can take on different shapes and sizes.

On the top cover 14 is a control panel 19. As seen in FIG. 1, the control panel 19 has a dial 16, and a plurality of buttons 18 which allows the user to control the operations of the dehydrator 2 described later. The control panel 19 allows the user to select the different dehydration methods, such as temperature, humidity levels, or timing. A display panel 20 is located near the control panel 19. The display panel 20 provides feedback to the user regarding the operation and status of the dehydrator 2. In addition, a light display 42 provides feedback to the user concerning the current operation of the dehydrator 2. When the dehydrator 2 is activated, the light display 42 is illuminating. The light display 42 may provide different colors to provide feedback regarding which options were selected by the user. The light display 42 must be large enough and bright enough to allow the user to quickly determine the status of the dehydrator 2 from a distance.

The front door 6 provides access inside the housing unit 4. The front door 6 is attached to the housing unit 4 such that it allows the user to easily open and closed the front door 6. When the front door 6 is in the closed position, a deliberate force is required to open the front door 6. Located on the inside of the front door 6 is a reflector 22. The reflector 22 is made of material which reflects the heat and infrared energy back into the confined space 15 causing the food to be dehydrated evenly.

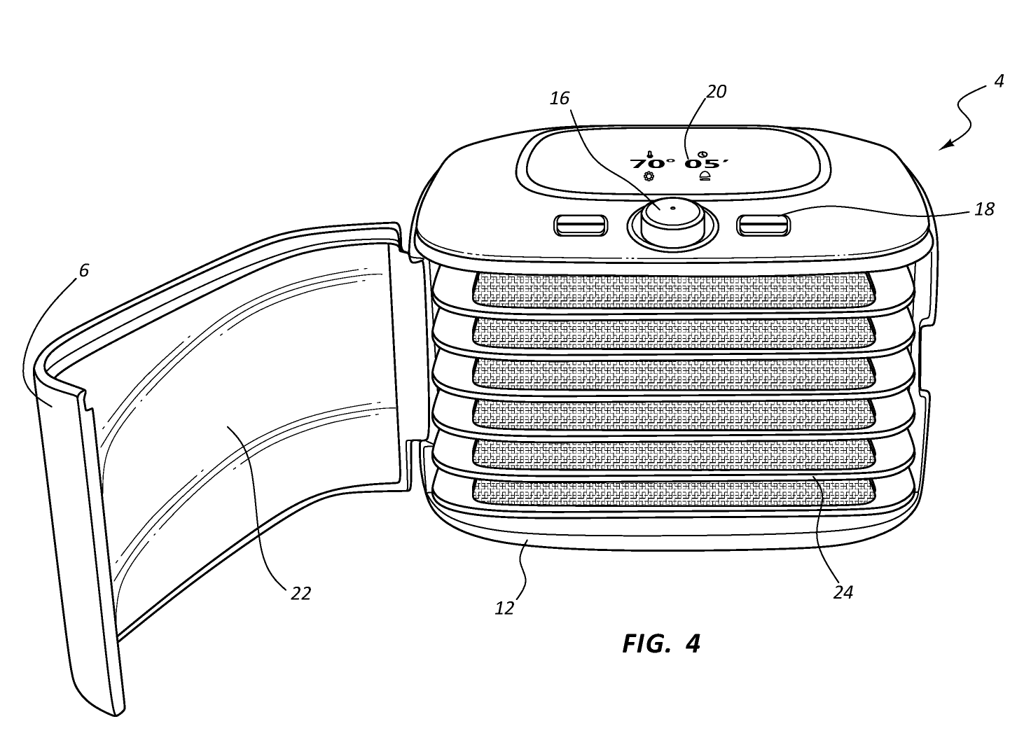

As shown in FIG. 4 several removable trays 24 are located inside the housing unit 2. The trays 24 support the food material (not shown) while the food is being dehydrated. The trays 24 are supported and held in place by brackets 25 located on the side walls 10. Generally, the trays 24 are made of screens that allow air to flow unobstructed through the trays 24. The trays 24 may be made of any ridged material. However, the preferred material is stainless steel. Although shown with trays 24, the dehydrator 2 may operate without the trays 2 or may operate with other devices which will support the food. One skilled in the art will recognize that the trays 24 may form a portion of the housing unit 4.

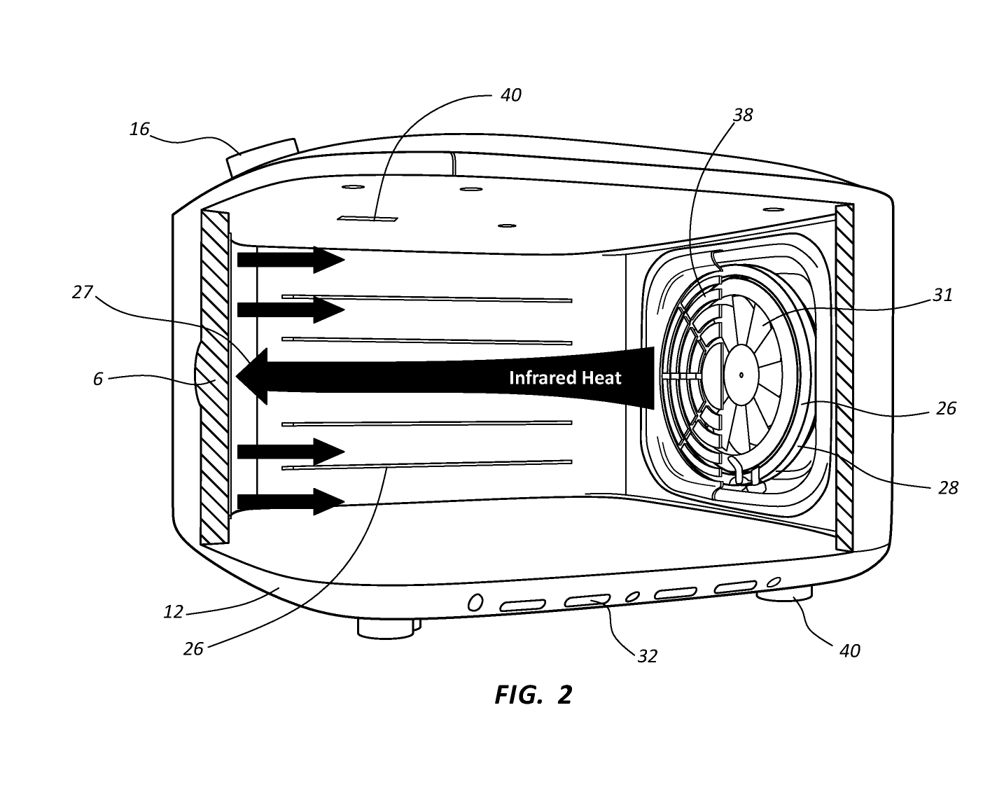

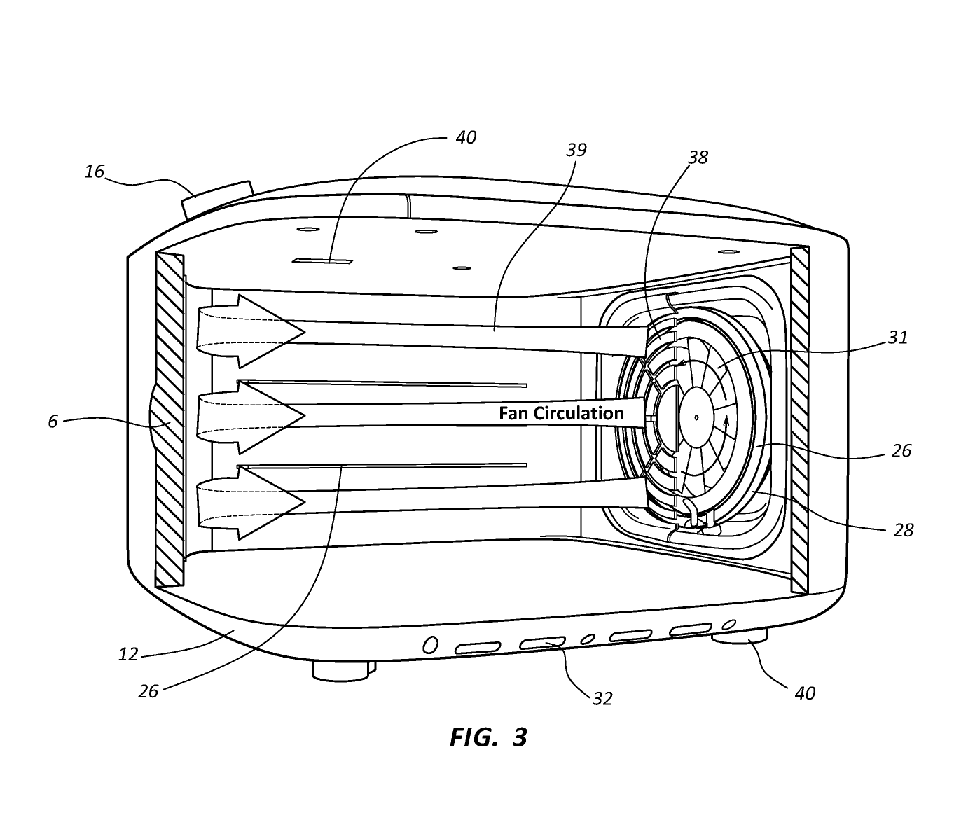

As best seen in FIGS. 2 and 3, located in the housing unit on the back panel 8 is an infrared element 26 and a heating element 28. The infrared element 26 generates infrared energy 27. The power consumption of the infrared element 26 has a range of 1000 Watts to 25 Watts. The power consumption may be adjusted by the user or set during manufacturing. The power consumption of the heating element 28 has a range of 1500 Watts to 100 Watts. Similar to the infrared element 26, the power consumption of the heating element 28 may be adjusted by the user or set during manufacturing. In the alternative, the temperature or humidity levels inside the housing unit 4 may be set by the user and the control panel will regulates the power consumption of the heating element 28 and infrared element 26.

The infrared element 26 and the heating element 28 are separated from the confined space 15 by a protective screen 38. The protective screen 38 must allow the infrared energy and air to flow uninterrupted between the infrared element 26 and the heating element 28 and the confided space 15. Yet, the protective screen 38 must be ridged enough to protect the infrared element 26 and the heating element 28 during use and to protect the user from getting injured.

A humidity sensor 40 and temperature sensor 41 are located within the confined space 15. The humidity sensor 40 and temperature sensor 41 provide feedback to the control panel 19 regarding the humidity levels and temperature within the confined space 15. The humidity levels and temperature may be displayed on the display panel 20 or set to turn off the dehydrator when a certain humidity level or temperature is achieved in the confined space. The humidity level and temperature may be adjusted by the user or set by the manufacture. In practice, when the humidity level reach a range between of 20% to 0%, the dehydrator 2 would turn off. In practice, the humidity sensor 40 and temperature sensor 41 may be used to adjust the power consumption and intensity of the infrared element 26 and the heating element 28.

A blower 30 is located behind the infrared element 26 and the heating element 28. The blower 30 comprises a driving motor (not shown) and a blower fan 31. The blower 30 draws in air from the outside of the housing unit 4 through a plurality of vent openings 35 on the back panel 8. The air must travel through a filter cover 34 and an air filter 36 before entering the housing unit 4. After traveling past the blower 30, the air travels past heating element 28, increasing the temperature of the air. If the infrared element 26 is active, this infrared energy also sterilizes the air. The blower 30 forces the air into the confined space 15 towards the food and trays 24. The air is then ejected out of side ports (not shown) and through channels (not shown) located inside the side wall 10 and outside the housing unit through ejection vents 32 located on the bottom 12.

While a preferred embodiment of the invention of the dehydrator has been shown and described herein, it should be understood, that although the description above contains many specificities that should not be construed as limiting the scope of the invention. Thus, the scope of the embodiment should be determined by the appended claims and their legal equivalents rather than by the examples given.

The invention claimed is:

1. A device for dehydrating food comprising,
(a) a housing unit forming an interior space comprising,
(i) a control panel for controlling the operation of the device;
(ii) a display panel for providing feedback regarding the status of the device;
(iii) a blower for forcing air through the housing unit;
(iv) an import and an exhaust port for allowing the flow of air through the housing unit;
(v) a heating element to heat the air flowing through the housing unit;
(vi) an infrared element for creating infrared energy;
(b) a plurality trays to support a food item.

2. The device as recited in claim 1, wherein the infrared element power output is adjustable.

3. The device as recited in claim 1, wherein the heating element power output is adjustable.

4. The device as recited in claim 1, further comprising a humidity sensor and a temperature sensor.

5. The device as recited in claim 1, wherein the trays are removable from the housing unit.

6. The device as recited in claim 4, wherein the humidity level and a temperature is shown on the display panel.

7. The device as recited in claim 1, wherein a portion of housing unit interior wall has a reflective material so that the infrared energy is reflected back into the housing unit.

8. A method for dehydrating food comprising:
(a) selecting a housing unit comprising,
(i) a control panel for controlling the operation of the device;
(ii) a display panel for providing feedback regarding the status of the device;
(iii) a blower for forcing air through the housing unit;
(iv) an import and an exhaust port for allowing the flow of air through the housing unit;
(v) a heating element to heat the air flowing through the housing unit;
(vi) an infrared element for creating infrared energy;
(b) at least one tray;
(c) placing a food item on the tray;
(d) causing the blower to draw air into the housing unit and increasing the temperature of the air with the heating unit, then discharging the air from the housing unit;
(e) causing the infrared element to emit infrared energy into the housing unit.

9. The method of claim 8 wherein the housing unit includes a humidity sensor and a temperature sensor.

10. The method of claim 8 wherein when the air temperature or humidity level reach a predetermined condition, the dehydrator shuts off.

11. The method of claim 10 above wherein the predetermined condition is adjustable by the control panel.

12. The method of claim 8 wherein the operator may choose the heating element, the infrared element, or both to dehydrate the food.
